(19) United States
(12) Patent Application Publication
(10) Pub. No.: US 2011/0093199 A1
(43) Pub. Date: Apr. 21, 2011

(54) CHARACTERIZATION OF LOGGING TOOL PERFORMANCE

(76) Inventors: Mark Gerard KITTRIDGE, Houston, TX (US); Chad Barrett Roller, Houston, TX (US)

(21) Appl. No.: 12/893,891

(22) Filed: Sep. 29, 2010

Related U.S. Application Data
(60) Provisional application No. 61/246,674, filed on Sep. 29, 2009.

(51) Int. Cl. G06F 17/18; G01V 9/00; G06F 19/00

(52) U.S. Cl. 702/6; 702/179

(57) ABSTRACT

A method for determining the measurement precision of a formation evaluation tool in a borehole comprises: a) conveying the formation evaluation tool into the borehole, b) using the formation evaluation tool to make measurements, and c) analyzing the measurements using mean squared difference stability statistics to generate an output indicative of measurement precision. Step c) may comprise using an Allan variance to assess the measurements taken in step b). The method may further include deriving an optimum logging speed from the analysis performed in step c), which may occur at the lowest value of the Allan variance.

### RELATED CASES

This application claims priority to U.S. provisional application No. 61/246,674, which was filed on 29 Sep. 2009 and is incorporated herein by reference.

### FIELD OF THE INVENTION

This invention relates generally to methods for assessing the performance of pulsed neutron logging tools in a downhole environment and more particularly to the use of statistical techniques to characterize the performance of a logging tool as a function of time or logging speed.

### BACKGROUND OF THE INVENTION

Oil or gas wells are often surveyed in order to assess one or more properties of the surrounding formation. The surveys are typically carried out using electronic measuring instruments that are conveyed into the borehole on a device such as a cable, a wireline, slickline, drill pipe or coiled tubing. The desired measurements may be carried out using electrical, acoustical, nuclear and/or magnetic signals that pass through the formation and/or the fluids within the borehole. The signals that are received at a receiver contain information about the material(s) through which they passed. Thus received signals can be used to measure the desired property of the formation and/or fluids.

By way of example only, pulsed neutron spectroscopy (PNS) logs, also referred to as carbon/oxygen logs, are designed to detect and quantify hydrocarbon saturations behind the well casing. These “statistical” nuclear tools rely on averaging to improve the signal-to-noise ratio and uncertainty. The more slowly the log is carried out, the lower the uncertainty in the measured saturations. As such, the estimation of tool performance is based on the premises that additional averaging improves the signal-to-noise ratio by a factor of √τ or √n, where τ is the averaging time or n is the number of samples averaged.

However, this approach assumes that the noise of the logging tool is uncorrelated with finite variance. Because this is not always the case, this mode of estimation will not always predict tool performance accurately.

Thus, it remains be desirable to provide a logging method in which the inefficiencies of the prior art are overcome. In particular, a method for determining the uncertainty of measurements as a function of logging speed is desired.

### SUMMARY OF THE INVENTION

Preferred embodiments of the invention provide a method for determining the uncertainty of measurements as a function of logging speed, thereby allowing selection of an optimum logging speed. The method assessing the performance of a logging tool by acquiring a logging signal at a constant depth, performing a variance analysis on the acquired data, and using the results of the variance analysis to output a conclusion regarding the uncertainty of the measurements.

According to certain embodiments, the method may comprise a) conveying the formation evaluation tool into the borehole, b) using the formation evaluation tool to make measurements, and c) analyzing the measurements using mean squared difference stability statistics to generate an output indicative of measurement precision. Step c) preferably comprises using an Allan variance to assess the measurements taken in step b). The method may further include deriving an optimum logging speed from the analysis performed in step c), which may occur at the lowest value of the Allan variance.

In other embodiments, the method may comprise a) conveying a formation evaluation tool into the borehole, b) moving the formation evaluation tool at a logging speed while making measurements with the tool, c) analyzing the measurements using mean squared difference stability statistics to generate an output indicative of measurement precision, d) determining whether the measurement precision indicated in step c) is acceptable, and e) controlling the logging speed based on the determination made in step d).

### BRIEF DESCRIPTION OF THE DRAWINGS

For a more detailed understanding of the invention, reference is made to the accompanying Figures wherein:

FIG. 1 is an exemplary plot showing measurements over time; and

FIG. 2 is an exemplary plot of the data of FIG. 1 after an assessment in accordance with the present invention has been run.

### DETAILED DESCRIPTION OF A PREFERRED EMBODIMENT

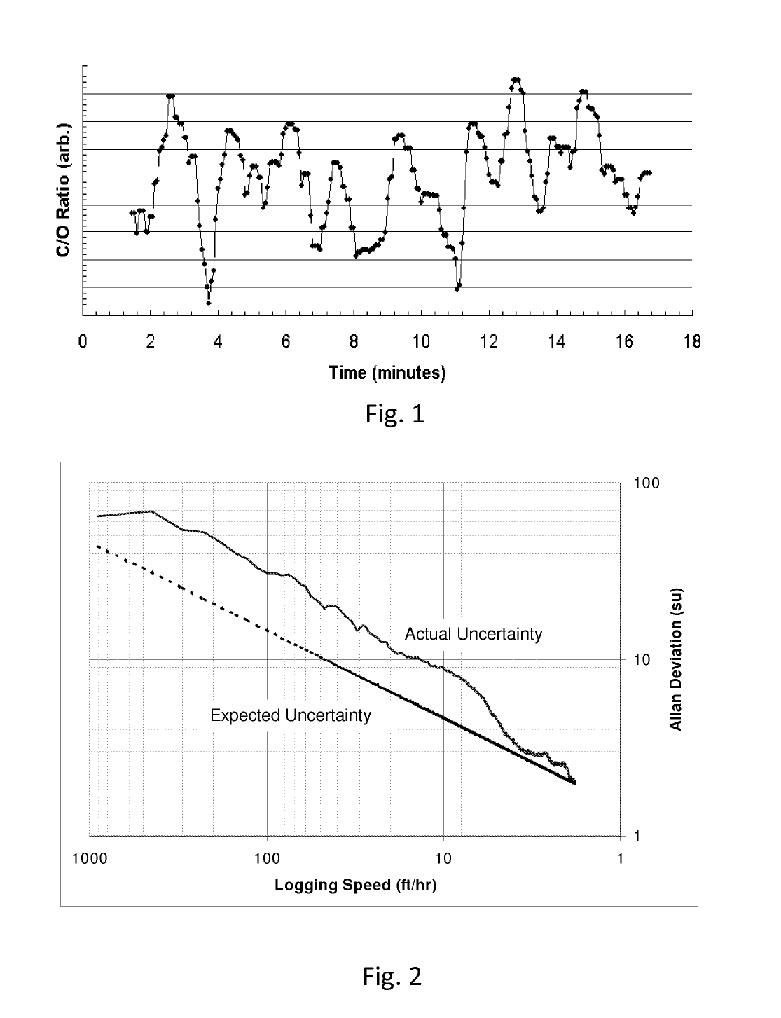

When it is desired to carry out the invention, a logging tool is lowered into a well. The logging tool is held stationary at one or more predetermined depths and a series of measurements is made at each depth. For each depth, the data comprise a set of measurements over time. The total time period at each depth may be in the range of 1 to 60 minutes, and is more preferably in the range of 10 to 30 minutes. The frequency at which data are collected may be in the range of 1 to 60 data points per minute, and is more preferably in the range of 15 to 30 data points per minute. FIG. 1 is an example of a set of data collected at a single depth over a period of 16 minutes and with a data collection rate of 15 data points per minute. The data may include any of various types of signal, including but not limited to: PNS logs, density logs, neutron porosity, and pulsed neutron capture log (also referred to as sigma logs). Similarly, the data may be indicative of any of various properties of the reservoir, including but not limited to: porosity, hydrocarbon saturation, lithology, and the like.

Once the desired data have been collected, the data set for each depth is analyzed. The analysis preferably includes an assessment of the uncertainty of the measurements. One preferred technique for assessing the uncertainty of the measurements comprises calculating the Allan variance for each data set. The Allan variance, also known as a two-sample variance, is defined as one-half of the time average of the squares of the differences between successive readings of the fractional frequency error sampled over the sampling period.

The Allan variance is given by

$${σ}_{y}^{2} ( τ ) = \frac{1}{2} 〈 {( {y}_{n + 1} - {y}_{n} )}^{2} 〉 ,$$

where yₙ is the normalized frequency departure, averaged over sample period n, and τ is the time per sample period. The samples are taken with no dead-time between them.

$${y}_{n} = {〈 \frac{δν}{ν} 〉}_{n} ,$$

where υ is the frequency, δυ is the frequency error, and the average is taken over sampling period n. For a clock, the time error, xₙ, at sampling period n, is the sum of the preceding frequency errors, given by

$${x}_{n} = {x}_{0} + τ {\sum }_{i = 0}^{n - 1} {y}_{i} .$$

This can be reversed to compute frequency error from time error measurements

$${y}_{n} = \frac{1}{τ} ( {x}_{n + 1} - {x}_{n} ) ,$$

which leads to the equation for Allan variance in terms of time errors:

$${σ}_{y}^{2} ( τ ) = \frac{1}{2 {τ}^{2}} 〈 {( {x}_{n + 2} - 2 {x}_{n + 1} + {x}_{n} )}^{2} 〉 .$$

The Allan variance depends on the time period used between samples and is therefore a function of the sample period as well as the distribution being measured, and is displayed as a graph rather than a single number. A low Allan variance is a characteristic of a clock with good stability over the measured period.

In the example of FIG. 1, the time series carbon/oxygen ratio data was analyzed using the Allan variance and plotted as a function of averaging time (τ) or logging speed. FIG. 2 is a plot showing the Allan variance for the data of FIG. 1. Notably, the uncertainty calculated using the Allan variance is higher than the expected uncertainty. The expected uncertainty or standard deviation is commonly provided by the logging companies or service providers and is based on the theoretical increase in the signal-to-noise ratio as the averaging time increases. It is commonly assumed that the signal-to-noise ratio improves by a factor of the square root of the averaging time. At times, the actual uncertainty is larger than the expected uncertainty due to the presence of low frequency noise or random walk noise at levels comparable to the expected uncertainties and which averaging cannot reduce.

In other embodiments, any suitable variation of the Allan variance can be used, including but not limited to the modified Allan variance, the total variance, the moving Allan Variance, the Hadamard variance, the modified Hadamard variance, the Picinbono variance, the Sigma-Z variance. All these variances and variations thereof can be categorized as mean-square averages of the output of a finite-difference filter acting, not on the phase or frequency of samples, but on their cumulative sums.

Lastly, the tool performance and optimum logging speed were determined from analysis of the resulting Allan variance. In FIG. 2 it can been seen that the Allan variance is lowest at logging speeds less than 10 ft/sec and is particularly low at speeds of about 2 to 5 ft/sec. Thus, the optimization technique of the present invention would suggest the use of a logging speed in the range of 2 to 5 ft/sec for the system in question. In practice, the optimum logging speed will be determined based on the required uncertainty dictated by the purpose of the logging job.

What is claimed is:

1. A method for determining the measurement precision of a formation evaluation tool in a borehole, the method comprising:
a) conveying the formation evaluation tool into said borehole;
b) using the formation evaluation tool to make measurements; and
c) analyzing said measurements using mean squared difference stability statistics to generate an output indicative of measurement precision.

2. The method according to claim 1 wherein step c) comprises using an Allan variance to assess the measurements taken in step b).

3. The method according to claim 1, further including deriving an optimum logging speed from the analysis performed in step c).

4. The method according to claim 3 wherein step c) comprises using an Allan variance to assess the measurements taken in step b) and the optimum logging speed occurs at the lowest value of the Allan variance.

5. A method of conducting logging operations in a borehole, the method comprising:
a) conveying a formation evaluation tool into said borehole;
b) moving the formation evaluation tool at a logging speed while making measurements with the tool;
c) analyzing said measurements using mean squared difference stability statistics to generate an output indicative of measurement precision;
d) determining whether the measurement precision indicated in step c) is acceptable; and
e) controlling the logging speed based on said determination made in step d).

6. The method according to claim 5 wherein step c) comprises using an Allan variance to assess the measurements taken in step b).

7. The method according to claim 5, further including deriving an optimum logging speed from the analysis performed in step c).

8. The method according to claim 7 wherein step c) comprises using an Allan variance to assess the measurements taken in step b) and the optimum logging speed occurs at the lowest value of the Allan variance.
